(19) United States
(12) Patent Application Publication
(10) Pub. No.: US 2021/0320994 A1
(43) Pub. Date: Oct. 14, 2021

(54) SELECTIVE AND NETWORK BASED AUTOMATED ANSWERING OF AUDIO/VIDEO CALLS FOR COMMUNICATION DEVICES

(71) Applicant: Telefonaktiebolaget LM Ericsson (publ), Stockholm (SE)

(72) Inventors: Ester Gonzalez De Langarica, Vitoria (ES); Charles Hegarty, Bromma (SE); José Manuel Alfonso, Enskededalen (SE)

(21) Appl. No.: 17/271,747

(22) PCT Filed: Aug. 28, 2018
(86) PCT No.: PCT/SE2018/050859

§ 371 Date: Feb. 26, 2021

(51) Int. Cl. H04M 1/64; H04M 3/436; H04L 29/06

(52) U.S. Cl. CPC H04M 1/64; H04M 3/4365; H04L 65/1006; H04M 2201/50; H04L 65/1083; H04L 65/1016; H04L 65/1069

(57) ABSTRACT

The present disclosure relates to a network node, a communication device, capable of selective and network based automated answering of audio/video calls. When there is a provision in the network node, that an in-coming call from a calling party is to be auto-answered by a call receiving party, the network node adds an indication to a part of the call. The call is then provided to the call receiving party, where the indication instructs it to auto-answer the call. It is advantageous that selective and network-based automated answering of calls is provided to communication devices such as wearables, 5G- or IoT devices.

### TECHNICAL FIELD

This disclosure relates to automated answering of calls. In more particular, it relates to methods, a network node and communication device for selective and network based automated answering of audio/video calls.

### BACKGROUND

Currently, some telephones have an auto-answer feature. For instance, a call may be answered, or declined, by using voice. Once a call is answered with a voice command, a speakerphone is turned on. Alternatively, calls may be answered automatically after 2 seconds, and headset or a Bluetooth device is connected to the incoming call. There is a drawback with such auto answer features, in that when enabling an automatic answer, all incoming calls will be automatically answered.

In addition, there exist over-the-top (OTT) applications providing advanced auto-answer functions, in which it is allowed to indicate to automatically answer to only particular users.

There is a drawback in that OTT applications need to be installed in all single devices in a multi-device scenario. Also, some devices, such as wearables, or Internet of things (IoT) devices, often have limited memory, for which reason OTT applications may not be possible to run in these devices.

Also, native settings in a phone does not provide an opportunity to auto-answer to only particular users, as auto-answer function is applicable to either all or none of the incoming calls.

There are application programming interfaces (APIs) defined by global system for mobile communication association (GSMA) which allow a network operator to expose network capabilities that are useful for auto-answer functions. One of these network capabilities is an audio call capability.

There is however a demand for a more versatile answering function that can be enabled to particular users only.

### SUMMARY

It is an object of embodiments of the disclosure to address at least some of the issues outlined above, and this object and others are achieved by a network node, a communication device, methods performed therein, a computer program and a computer-readable storage medium for providing automated answering of a call from a calling party, according to the appended independent claims and by embodiments according to the dependent claims.

According to an aspect, this disclosure provides a method for providing automated answering of a call from a calling party, wherein the call comprises an audio or video call, and wherein the method is performed in a network node. The method comprises receiving the call from the calling party, where the call is a call involving a call receiving party. When there is a provision in the network node for the call receiving party, that calls from the calling party are to be auto-answered, the method also comprises adding to a part of the call, an indicator indicating that the call is to be auto-answered by the call receiving party. In addition, the method comprises providing the call, comprising the indicator, to the call receiving party, such that the call may be auto-answered.

According to another aspect, this disclosure provides a method for providing automated answering of a call from a calling party, wherein the call comprises an audio or video call, and wherein the method is performed by a communication device of a call receiving party. The method comprises receiving a call from a calling party via a network node, wherein the call comprises an indicator. The method further comprises identifying the indicator as an indicator indicating that the call is to be auto-answered. In addition, the method comprises auto-answering the call by the call receiving party, based on said identifying of said indicator.

According to another aspect, this disclosure provides a computer program for providing automated answering of a call from a calling party, the computer program comprising instructions which, when executed on at least one processor, cause the at least one processor to carry out the methods according to the aspects as described above.

According to yet another aspect, this disclosure provides a computer-readable storage medium, having thereon said computer program.

According to yet another aspect, this disclosure provides a network node that is capable of providing automated answering of a call from a calling party, where the call comprises an audio or video call. The network node comprises a processor circuit and a memory having instructions executable by said processor circuit. When executing the instructions, the processor circuit is configured to receive the call from a calling party, where the call is a call involving a call receiving party. When there is a provision in the network node for the call receiving party, that calls from the calling party are to be auto-answered, the processor circuit is configured to add to a part of the call, an indicator indicating that the call is to be auto-answered by the call receiving party. Also, when executing the instructions, the processor circuit is configured to provide the call to the call receiving party, such that the call can be auto-answered.

According to still yet another aspect, this disclosure provides a communication device that is capable of providing automated answering for a call-receiving party of a call from a calling party via a network node, where the call comprises an audio or a video call. The communication device comprises a processor circuit and a memory having instructions executable by said processor circuit. When executing the instructions, the processor circuit is configured to receive a call from a calling party via a network node, wherein the call comprises an indicator. When executing the instructions, the processor circuit is further configured to identify the indicator as an indicator indicating that the call is to be auto-answered by the call receiving party. In addition, when executing the instructions, the processor circuit is also configured to auto-answer the call by the call receiving party, based on said identifying of said indicator.

The present disclosure comprises the following advantages:

Embodiments disclosed herein present a controlled and consistent way to provide selective and network-based automated answering in communication devices such as wearables, 5G- or IoT devices. Embodiments are applicable to scenarios in which there are multiple IoT devices and/or multiple persons or users.

### BRIEF DESCRIPTION OF THE DRAWINGS

Embodiments will now be described in more detail, and with reference to the accompanying drawings, in which:

FIG. 1 schematically presents a general call case for automated answering, according to the present disclosure;

FIGS. 2 and 3 schematically present further call cases for automated answering according to embodiments of the present disclosure;

FIG. 4 presents an example of a call case for automated answering according to an embodiment of the present disclosure;

FIGS. 5 and 6 present flow charts of methods for providing automated answering, according to embodiments of this disclosure; and

FIGS. 7 and 8 schematically present a network node and a communication device, respectively, according to embodiments of the present disclosure.

### DETAILED DESCRIPTION

In the following description, different embodiments of the disclosure will be described in more detail, with reference to accompanying drawings. For the purpose of explanation and not limitation, specific details are set forth, such as particular examples and techniques in order to provide a thorough understanding.

As mentioned in the background section, there are application programming interfaces (APIs) defined by global system for mobile communication association (GSMA) which allow a network operator to expose network capabilities that are useful for auto-answer functions.

Also, multimedia telephone application server (MTAS) implements an earlier version of such an API providing audio call network capabilities. Although older, this earlier version uses Parlay X protocol (SOAP) provides similar functionalities as said API.

One example of a use case within which a call is initiated via voice, is presented below. User A is here denoted the party that is calling, i.e. the calling party. In this use case, a cloud-based voice service is used, and is herein denoted “Axel”.
i) User A: “Hi Axel! I want to call user B.”
ii) Axel: “I am calling user B on your behalf.”
iii) The cloud then triggers the use case by sending an hyper-text transfer protocol (HTTP) request to an end-point where there a web application is listening. The web application may then translate the request into an AudioCallREST request to a multimedia telephony application server (MTAS).
iv) MTAS then invites user A, and once user A picks up the call, MTAS invites user B and when user B answers, user A and user B will be connected in the call.

Hence user A will have to pick up the call, before user B is invited by MTAS.

However, user A may not be able to pick up the call. For instance, user A may in some way be hindered, busy or be occupied by duties or actions, requiring her/his full attention. Alternatively, user A may be disabled such that picking up the call requires much effort.

Picking up an in-coming call may also be inconvenient to user A, although he/she, i.e. user A, may physically be able to actually pick up the call.

Also, there is a need for an auto-answer function that is user-selective, i.e. that may be activated for specific users or specific calling parties. It is thus an advantage to pick up calls from selected calling parties or users. Hence it is not appreciated to pick up calls irrespective of whom the calling party is.

Hence, there is a demand for a more versatile answering function that can be enabled to particular users only.

The present disclosure comprises features implemented in a network node as well as in a communication device used, such as a user equipment (UE), to allow answering to a call to be automatedly handled when the call comes from a calling party, that has been authorized by the call receiving party. This authorization may be accomplished by a provision in a network node for the call receiving party that calls from the calling party, or at least initiated by the calling party, are to be auto-answered by the call receiving party. This provision in the network node may comprise one or more lists of calling parties, such as contacts or users, for each call receiving party. The one or more lists may comprise a white list of contacts, calls of which are to be auto-answered by the call receiving party. The one or more lists of calling parties may also comprise a black list of contacts, calls from which must not be auto-answered under any circumstances.

Generally, however, if a calling party is absent from a white list of calling parties, for a call receiving party, the network node will identify that there is no provision that calls from the calling party are to be auto-answered by the call receiving party. In such a special case, answers to calls from the calling party will thus not be handled automatedly by the call receiving party.

The present disclosure provides a selective and network-based auto-answer function of audio or video calls for communication devices. When there is a provision in a network node, an indicator is added to a part of the call, which indicator is intended to instruct to the call receiving party that the call is to be auto-answered by the call receiving party. The call comprising the instruction is then provided, to the call receiving party, such that the call can be auto-answered by the call receiving party.

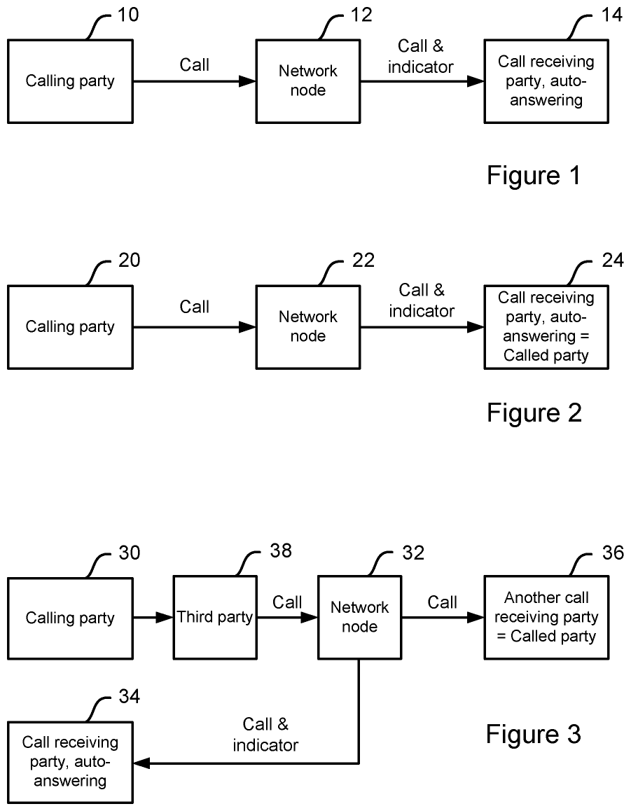

FIG. 1 schematically presents a general use case for automated answering of a call from a calling party 10, according to the present disclosure. In addition to the calling party 10, FIG. 1 also comprises a network node 12 and a call receiving party 14. The call comprises an audio call or a video call.

In this general use case, the network node 12 receives the call from the calling party 10, wherein the call involves the call receiving party 14. The call typically identifies the call receiving party. The calling party 10, at least, initiates the call. The call from the calling party 10 may be intercepted by the network node 12.

The network node 12 thus receives the call, and when there is a provision in the network node for the call receiving party, that calls from the calling party are to be auto-answered, the network node adds to a part of the call, an indicator that indicates that the call is to be auto-answered by the call-receiving party. The network node 12 then provides the call now comprising said indicator to the call receiving party, such that the call can be auto-answered.

The call receiving party 14, when receiving the call, identifies the indicator as an indicator indicating that the call is to be auto-answered.

It is noted that the provision in the network node is for the call receiving party, and that calls from the calling party are to be auto-answered. Calls from the calling party may refer to calls per caller or user A. Alternatively, calls from the calling party may refer to calls from a specific type of device.

In the general use case, the network node 12 may further determine whether there is provisioned in the network node that the call receiving party is a party for which calls, which are at least initiated by the calling party, are to be auto-answered by the call receiving party 14.

Determining whether the call is to be auto-answered by the call receiving party may comprise looking up in a list of parties for the call receiving party, whether the list of parties includes the calling party as a party from which calls are to be auto-answered by the call receiving party.

Looking up in a list of parties, may be regarded as one way to check whether a criterion involving a calling party and call receiving party is fulfilled, and more precisely, whether there is a provision in a network node for the call receiving party, that the calling party is a party, from which calls are to be auto-answered by a communication device representing the call receiving party.

FIG. 2 schematically presents a first use case for automated answering of a call from a calling party 20, according to the present disclosure. In addition to the calling party 20, FIG. 2 also comprises a network node 22 and a called party 24. The call comprises an audio call or a video call. In this use case, it is noted that the call receiving party 14 equals to the called party of said call, i.e. the party being called by said call.

The calling party 20, typically User A, thus calls the called party 24, via the network node 22. When it is provisioned within the network node 24 that calls from the calling party are to be auto-answered by the called party, the network node 22 adds an indicator to a part of the call, where the indicator is designed to instruct the called party, when the call is provided to the called party, that the call is to be auto-answered by the called party 24. At the time when the call is provided to the called party from the network node, the called party identifies the indicator to an indicator instructing the called party to auto-answer the call, the called party thus auto-answers the call.

The call from the calling party may comprise a SIP INVITE B, thus an invitation to invite user B in the call. When the call is provided from the network node, the call may comprise the SIP INVITE B now comprising a header that comprises said indicator. Also, the indicator may comprise a flag or a parameter, which indicates that a call is to be auto-answered by the call receiving party. The indicator to be added to the call, when there is a provision in the network node may comprise an element, such as a SIP header, to be added into a SIP INVITE to user B to indicate that the call receiving party, such as a user equipment (UE) will have to automatically answer the call, since the call comes, at least originally, from user A that is a party from which calls are to be auto-answered. User A may for this reason be authorized by the call receiving party and/or to be present in a white list of the call receiving party.

It is noted that this disclosure is also applicable to a multi-device and multi-user scenario. An indication that may be regarded as a token of a provision in a network node for a call receiving party, that calls from a calling party are to be auto-answered. For this reason it may be considered to be linked to the calling party and the call receiving party. For this reason, an indication may thus be used in a multi-device and multi-user scenario, since auto-answering is effected only for calls from a calling party and for a call receiving party, where these both parties match those parties for which the indicator was added to the call.

An indication may thus be included in a number of INVITE messages sent to a various devices, and auto-answer will be triggered only when matching is achieved between a calling party and a call receiving party, by using the indicator.

An example of this use case is an event of an accident or emergency. Imagine that an elevator is trapped and an elevator operator or service team needs to find pout the status of the elevator and whether anyone is trapped inside. In general, the elevator operator has no information of who is trapped.

Upon installing the elevator, a communication device may be built in, and a consent is given to auto-answer all calls from the elevator operator. This consent may be one example of a provision in a network node that calls, for the elevator, from elevator operator are to be auto-answered.

Another example of this use case comprises a vehicle or car, and upon experiencing an accident, or as a response to an alarm initiated by a driver of the vehicle, a service function calls the vehicle. The vehicle being a call receiving party has in advance authorized the service function, such that a call directed to the vehicle will be added an indication instructing that the call is to be auto-answered by the vehicle. If one or more persons are trapped, or just still seated, in the vehicle and/or have become unable to take the call, providing auto-answering of a call is likely to be valuable and may be crucial to the persons in the vehicle.

Still another example of a use case may be found when a conference call is scheduled, and the conference service sets up the conference call. A typical participant of a conference call gives her/his consent to allow auto-answering of the conference phone, being a call receiving party. When a conference call is established and an in-coming call is received by a conference phone, the conference phone may thus identify an indicator, established by a network, to instruct the conference phone to auto-answer the call. This is clearly beneficial.

The provision in a network node for a call receiving party, that calls from a calling party are to be auto-answered, may thus be applicable to calls for a specific type of a communication device, such as a conference phone, or a built-in car phone.

FIG. 3 schematically presents a second use case for automated answering of a call from a calling party 30, according to the present disclosure. In addition to the calling party 30, FIG. 3 also comprises a network node 32, a call receiving party 34, a called party 36, and a third party 38. The call herein also comprises an audio call or a video call. In this use case, it is noted that the network node 32 receives the call via a third party 38. The call receiving party 34 receives the call from the network node, the call comprising an indicator that instructs the call receiving party that the call is to be auto-answered. The network node 32 also provides the call to a second call receiving party 36, which second call receiving party 36 is the called party in this use, such that the call receiving party 34 and the called party 36, being the second call receiving party, will be connected to each other in the call.

The auto-answer function may thus be designed for the call receiving party to auto-answer the call, when identifying an indicator that instructs the call receiving party to auto-answer the call.

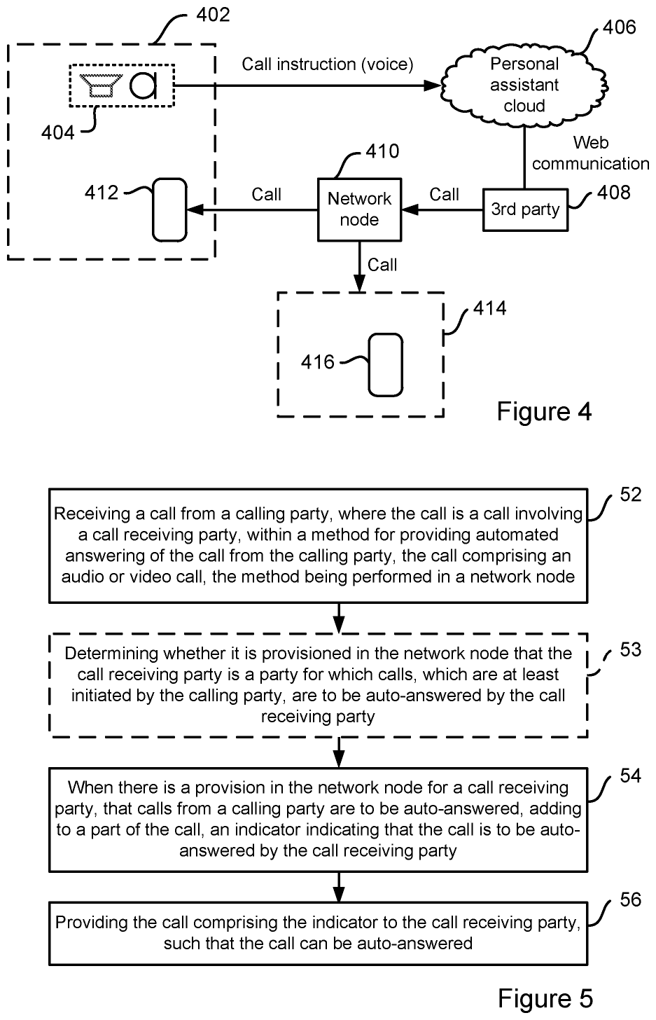

FIG. 4 schematically presents an example of the second use case as schematically illustrated in FIG. 3. FIG. 4 illustrates a calling party 402, an assistant device 404 of user A, a personal assistant cloud 406, a third party 408, a network node 410, a communication device 412 of user A, a user B 414, and a communication device 416 or user B.

Within this example, user A 402 thus instructs the assistant device 404 to call user B. This instruction may comprise a voice message to the assistant device, such as “Call B”. The assistant device 404 may then direct this call instruction in voice to the personal assistant cloud 406. Currently, there are a few examples of such clouds available.

The personal assistant cloud 406, triggered by the call instruction, communicates with a third party 408, and may for this reason send a HTTP request to the third party. This third party may be an end point server comprising a web application listening on the communication. This web application may in response to the communication transfer the call in the form of a call instruction “Call A+B” to the network node 410.

The network node 410 thus receives the call, at least originally from or at least initiated by, the calling party 402, being user A.

The network node 410 typically recognizes that the call was at least initiated by user A, and recognizes what party is the call receiving party of the call. Thus, the network node may check whether there is a provision in the network node, that calls from the calling party, i.e. user A, are to be auto-answered, or not.

Worded differently, the network node may thus determine whether there is a provision in the network node 410 that the call receiving party, here user A, is a party for which calls, which are at least initiated by the calling party, are to be auto-answered by said call receiving party.

When there is a provision in the network node 410 for the call receiving party, that calls from the calling party at to be auto-answered, the network node 410 adds to a part of the call, an indicator indicating that the call is to be auto-answered by the call receiving party.

The network node 410 may then provide the call to the call receiving party by sending a call invitation to user A, in the form of an INVITE A, where said call invitation comprises the indication instructing user A to auto-answer the call.

As the call instruction as received by the network node 410 was “Call A+B”, the network node 410 also provides an invitation to user B 414, being another call receiving party. Said another call receiving party is thus the called party in this case.

It is noted that assistant device 404 and the communication device 412 both represent user A. The assistant device 404 may comprise a microphone and a speaker, such that audio instructions can be received and confirmations, such as: “I am calling user B on your behalf” can be provided to user A when making the call, as a confirmation to the instruction “Call B”. Alternatively, or in addition, the assistant device may comprise a light emitting diode (LED) with which the assistant device may confirm and acknowledge receipt of an instruction.

It is further noted that the assistant device may comprise any third party application. Alternatively, the assistant device may belong to the operator.

FIG. 5 presents a flow chart of actions of a method according to embodiments of this disclosure. The method is for providing automated answering of a call from a calling party 10, 20, 30, 402, wherein the call comprises an audio or video call. The method is performed in a network node 12, 22, 32, 70, 410. The method comprises the following actions: Action 52: Receiving the call from the calling party, where the call is a call involving a call receiving party 14, 24, 34.

Action 52 may comprise receiving the call via a third party 38, 408.

Action 54: When there is a provision in the network node for a call receiving party, that calls from the calling party are to be auto-answered, the method also comprises adding to a part of the call, an indicator indicating that the call is to be auto-answered by the call receiving party.

Within action 54, adding the indicator indicating that the call is to be auto-answered by the call receiving party, may comprise adding a header entry into a header of the call, where the header entry indicates that the call is to be auto-answered by the call receiving party 14, 24, 34.

Action 56: In addition, the method comprises providing the call, comprising the indicator, to the call receiving party, such that the call can be auto-answered. Providing the call to the call receiving party may comprise sending a SIP invite to the call receiving party 34.

Action 53: The method may also comprise determining whether it is provisioned in the network node that the call receiving party is a party for which calls, which are at least initiated by the calling party, are to be auto-answered by the call receiving party 14, 24, 34.

Action 53 of determining may further comprise looking up in a list of parties for the call receiving party, whether the list of parties includes the calling party as a party from which calls are to be auto-answered by the call receiving party.

More than one list of parties may be provided. For instance, a white list of parties and a black list of parties may be provided. One of said white and blacks lists, may comprise parties from which calls are to be auto-answered, whereas the other list of said two lists may comprise parties from which calls shall not be auto-answered. Said one or two lists may thus be a list of contacts.

Typically, the white list comprises contacts that have been authorized by the call receiving party, to qualify for an auto-answer when a call to a call receiving party is made from a contact from said white list.

The call receiving party may be the called party 14, 24 of said call.

The method may further comprise providing the call to another call receiving party 36, which party is called by said call. Also, providing the call to said another call receiving party may comprise sending another SIP invite to said another call receiving party 36.

The call receiving party 34 may be the calling party 30, 402.

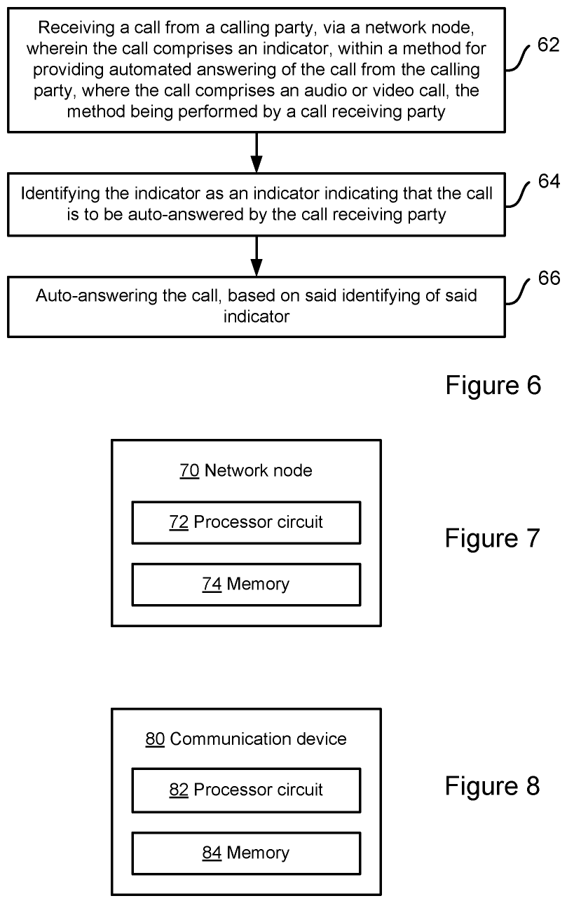

FIG. 6 presents a flow chart of actions of a method according to embodiments of this disclosure. The method is for providing automated answering of a call from a calling party 10, 20, 30, 402, wherein the call comprises an audio or video call. The method is performed by a communication device 80, 412. The method comprises the following actions:

Action 62: Receiving a call from a calling party via a network node, wherein the call comprises an indicator.

Action 64: Identifying the indicator as an indicator indicating that the call is to be auto-answered.

Action 66: Auto-answering the call by the call receiving party, based on said identifying of said indicator.

Within action 62, receiving a call from a calling party via a network node, may comprise receiving a SIP invite from the network node.

The indicator may comprise a header entry of a header of the call, wherein the header entry indicates that the call is to be auto-answered by the call receiving party.

The present disclosure also comprises a computer program for providing automated answering of a call from a calling party, the computer program comprising instructions which, when executed on at least one processor, causes the at least one processor to carry out the actions of each respective method, above.

The present disclosure also comprises a computer-readable storage medium, having thereon the computer program of above.

FIG. 7 schematically presents a network node 70 capable of providing automated answering of a call from a calling party, where the call comprises an audio or video call. The network node comprises a processor circuit 72 and a memory 74 that has instructions which are executable by the processor circuit 72. When executing these instructions, the network node is configured to receive the call from a calling party, where the call is a call involving a call receiving party 14, 24, 34.

When there is a provision in the network node for the call receiving party, that calls from the calling party 10, 20, 30, 402 are to be auto-answered, and when executing these instructions, the network node is configured to add to a part of the call, an indicator indicating that the call is to be auto-answered by the call receiving party.

In addition, when executing these instructions, the network node is also configured to provide the call to the call receiving party, such that the call can be auto-answered.

The network node 12, 22, 32, 70, 410 may also comprise an Internet protocol multimedia subsystem (IMS) core network (CN) node or a multi-media telephony (MMTel) application server (AS).

This disclosure also comprises a network node 70 that is capable of providing automated answering of a call from a calling party, where the call comprises an audio or video call.

The network node 70 is adapted to receive the call from a calling party, where the call is a call involving a call receiving party 14, 24, 34. Also, when there is a provision in the network node for the call receiving party, that calls from the calling party 10, 20, 30, 402 are to be auto-answered, the network node is adapted to add to a part of the call, an indicator indicating that the call is to be auto-answered by the call receiving party.

In addition, the network node is also adapted to provide the call to the call receiving party, such that the call can be auto-answered.

FIG. 8 schematically presents a communication device 80 capable of providing automated answering of a call from a calling party, where the call comprises an audio or video call.

The communication device comprises a processor circuit 82 and a memory 84 that has instructions which are executable by the processor circuit 82. When executing these instructions, the communication device is configured to receive a call from a calling party via a network node, wherein the call comprises an indicator. When executing these instructions, the communication device is also configured to identify the indicator as an indicator indicating that the call is to be auto-answered by the call receiving party. In addition, when executing these instructions, the communication device is also configured to auto-answer the call, based on said identifying of said indicator.

The communication device 80 may comprise a user equipment (UE), a fifth generation (5G) device or an Internet of things (IoT) device.

This disclosure also comprises a communication device 80 that is capable of providing automated answering of a call from a calling party, where the call comprises an audio or video call. The communication device 80 is adapted to receive a call from a calling party via a network node, wherein the call comprises an indicator. The communication device is also adapted to identify the indicator as an indicator indicating that the call is to be auto-answered by the call receiving party. In addition, the communication device is adapted to auto-answer the call, based on said identifying of said indicator.

It is noted that in enriched calling there is a possibility to indicate that a call is important. Indicating that a call is important may be done by adding an importance tag to the call. Moreover, this importance tag may in addition be used to indicate that such a call is to be automatedly answered by the call receiving party.

The present disclosure comprises a number of advantages, of which a few are:

Embodiments disclosed herein provide selective and network-based automated answering of calls in communication devices such as wearables, 5G- or IoT devices. Embodiments are applicable to scenarios in which there are multiple IoT devices and/or multiple persons or users.

### Abbreviations

5G fifth generation of wireless mobile communication

API application programming interface

AS application server

CN core network

GSMA global system for mobile communication association

HTTP hyper-text transfer protocol

IMS IP multimedia subsystem

IoT Internet of things

IP Internet protocol

LED light emitting diode

MMTel multi-media telephony

OTT over-the-top

PA personal assistant

UE user equipment

1. A method for providing automated answering of a call from a calling party, wherein the call comprises an audio or video call, the method being performed in a network node, wherein the method comprises:
receiving the call from the calling party, where the call is a call involving a call receiving party;
when there is a provision in the network node for the call receiving party, that calls from the calling party are to be auto-answered, adding to a part of the call, an indicator indicating that the call is to be auto-answered by the call receiving party; and
providing the call, comprising the indicator, to the call receiving party, such that the call can be auto-answered.

2. The method according to claim 1, further comprising determining whether it is provisioned in the network node that the call receiving party is a party for which calls, which are at least initiated by the calling party, are to be auto-answered by the call receiving party.

3. The method according to claim 2, wherein the determining, comprises looking up in a list of parties for the call receiving party, whether the list of parties includes the calling party as a party from which calls are to be auto-answered by the call receiving party.

4. The method according to claim 1, wherein the call receiving party is a called party of said call.

5. The method according to claim 1, wherein the receiving of the call comprises receiving the call via a third party.

6. The method according to claim 5, further comprising providing the call to another call receiving party, which party is called by said call.

7. The method according to claim 5, wherein said call receiving party is the calling party.

8. The method according to claim 1, wherein the providing of the call to the call receiving party, comprises sending a SIP invite to the call receiving party.

9. The method according to claim 8, wherein providing the call to said another call receiving party, comprises sending another SIP invite to said another call receiving party.

10. The method according to claim 1, wherein the adding of the indicator comprises adding a header entry into a header of the call, where the header entry indicates that the call is to be auto-answered by the call receiving party.

11. A method for providing automated answering of a call from a calling party, where the call comprises an audio or video call, the method being performed by a communication device of a call receiving party, the method comprises:
receiving a call from a calling party via a network node, wherein the call comprises an indicator;
identifying the indicator as an indicator indicating that the call is to be auto-answered; and
auto-answering the call by the communication device, based on said identifying of said indicator.

12. The method according to claim 11, wherein receiving the call comprises receiving a SIP invite the network node.

13. The method according to claim 11, wherein the indicator comprises a header entry of header of the call, wherein the header entry indicates that the call is to be auto-answered by the call receiving party.

14. A computer program for providing automated answering of a call from a calling party, the computer program comprising instructions which, when executed on at least one processor, cause the at least one processor to:
receive a call from a calling party, where the call is a call involving a call receiving party;
when there is a provision in a network node for a call receiving party, that calls from the calling party are to be auto-answered, add to a part of the call, an indicator indicating that the call is to be auto-answered by the call receiving party; and
provide the call, comprising the indicator, to the call receiving party, such that the call can be auto-answered.

15. (canceled)

16. A network node capable of providing automated answering of a call from a calling party, where the call comprises an audio or video call, the network node comprising a processor circuit and a memory, having instructions executable by said processor circuit, wherein said processor circuit when executing the instructions is configured to:
receive the call from a calling party, where the call is a call involving a call receiving party;
when there is a provision in the network node for the call receiving party, that calls from the calling party are to be auto-answered, add to a part of the call, an indicator indicating that the call is to be auto-answered by the call receiving party; and
provide the call to the call receiving party, such that the call can be auto-answered.

17. The network node according to claim 16, configured to be an Internet protocol multimedia subsystem, IMS, core network, CN, node or a multi-media telephony, MMTel, application server, AS.

18. A communication device capable of providing automated answering for a call-receiving party of a call from a calling party via a network node, where the call comprises an audio or a video call, the communication device comprising a processing circuit and a memory, having instructions executable by said processor circuit, wherein said processor circuit when executing the instructions is configured to:
receive a call from a calling party via a network node, wherein the call comprises an indicator;
identify the indicator as an indicator indicating that the call is to be auto-answered by the call receiving party; and
auto-answer the call, based on said identifying of said indicator.

19. The communication device according to claim 18, comprising a user equipment, UE, a fifth generation, 5G, device or an Internet of things, IoT, device.
